(19) United States
(12) Patent Application Publication
(10) Pub. No.: US 2024/0068493 A1
(43) Pub. Date: Feb. 29, 2024

(54) PRESSING CYLINDER FOR A MATERIAL CONVEYING DEVICE

(71) Applicant: Zehnder & Sommer AG, Burgdorf (CH)

(72) Inventors: Erich LOHNER, Burgdorf (CH); Urs FANKHAUSER, Burgdorf (CH)

(21) Appl. No.: 18/457,675

(22) Filed: Aug. 29, 2023

(30) Foreign Application Priority Data
Aug. 31, 2022 (EP) 22193244.5

(51) Int. Cl. F15B 21/00; F15B 15/14

(52) U.S. Cl. CPC F15B 21/00; F15B 15/1447; F15B 15/1457; B65H 20/02

(57) ABSTRACT

The present invention relates to a pressing cylinder for a material conveying device, in particular for a roller feed, comprising: a piston rod which is configured to engage with a movable component of the material conveying device; a cylinder space which is configured to at least partially guide the piston rod; a piston which is arranged in the cylinder space and which is connected to the piston rod; and a motor; wherein the piston rod comprises a first piston rod element and a second piston rod element which are configured such that a rotational movement of the first piston rod element causes a translational movement of the second piston rod element relative to the piston; wherein the motor is configured to cause the rotational movement of the first piston rod element.

### CROSS REFERENCE TO RELATED APPLICATIONS

This application claims the benefit of priority to European Patent Application No. 22193244.5, filed on Aug. 31, 2022, the disclosure of which is incorporated by reference herein in its entirety.

### TECHNICAL FIELD

The present invention relates to a pressing cylinder for a material conveying device, in particular for a roller feed, wherein the pressing cylinder comprises a piston rod, wherein the length of the piston rod is adjustable.

The present invention further relates to a material conveying device comprising at least one corresponding pressing cylinder, as well as a method for adjusting a length of a piston rod of a pressing cylinder.

### STATE OF THE ART

Material conveying devices, in particular roller feeds, are used, for example, for conveying and feeding, in particular for the clocked feeding of workpieces, such as strip material or tape material. For example, roller feeds are used in punching applications. The workpiece is fed in a clocked manner, wherein the clocking of the feeding is synchronized with a punching tool.

Likewise, roller feeds are known from other fields of application. For example, a roller feed can have a profiled roller and can impress or punch the corresponding profiling into the workpiece when feeding the workpiece.

The principle of the roller feed may be based on at least two rollers, of which at least one first roller is arranged on a first side (for example above) of the workpiece to be conveyed and a second roller is arranged on an opposite side (for example below) of the workpiece to be conveyed.

At least one of the rollers is a driven roller. For feeding/conveying, the workpiece is introduced into a gap which is formed between the rollers. The workpiece is then fed/conveyed by a synchronous rotation of the rollers. The rotational speed of the rollers determines the conveying or feed speed.

Material conveying devices usually have pressing cylinders which are intended to perform a plurality of functions.

On the one hand, pressing cylinders are intended to apply a contact pressure to a roller, for example to the upper roller. This contact pressure makes it possible to be able to transport a strip material introduced into the material conveying device as slip-free as possible. The pressure is usually applied by the pressing cylinder to a movable rocker which then passes on the pressure to the roller. The rocker can rotate about a pivot point.

Pressing cylinders are also intended to be able to bring about a raising of the roller in order to be able to introduce new strip material. This raising takes place, for example, by virtue of a piston in the cylinder being moved upward, as a result of which the rocker and the upper roller move upward.

Pressing cylinders are also intended to make possible an intermediate ventilation, which can also be referred to as “release”. The intermediate ventilation brings about a raising of the roller after each feed cycle of the strip material in order to release the strip material for a follow-up cutting tool. The follow-up cutting tool, for example a punching tool, can be better centered in this way and aligned with holes which have already been punched in advance. For example, strip materials can be aligned via pilot pins by means of pilot holes which have been punched in advance by the intermediate ventilation.

In order to perform the functions described above, at least the following requirements need to be fulfilled by a pressing cylinder. For example, the number of clock cycles (also feed clock cycles) per unit time represents an important parameter in material conveying devices. A clock cycle is the process of raising and lowering the piston in the pressing cylinder (a stroke). The number of clock cycles per unit time is also to be understood as the cycle rate and is usually expressed as the stroke/min. Increased cycle rates can significantly increase the efficiency of material conveying devices. The cycle rates of the pressing cylinder should consequently be increased. In addition, a multiplicity of different material thicknesses of strip material should be able to be processed. In addition, the construction should be structurally simple and cost-effective.

Conventional configurations do not satisfy this requirement profile. Conventional configurations comprise, for example, standard pneumatic cylinders or servo motors. Standard pneumatic cylinders usually have a long stroke. This long stroke limits the cycle rates (for example, only 300 strokes/min can be achieved). As a result of the long stroke and the associated larger friction surfaces, material wear is also disadvantageously noticeable. More frequent faults occur, which is why the configuration is cost-intensive overall. In addition, it is not possible to be able to flexibly adapt the cylinder to different strip material thicknesses. Conventional configurations by means of servo motors make it possible to change the position of the rocker in order to set the distance between a roller and the strip material. For this purpose, however, the servo motors are usually attached to the rocker in addition to pressing cylinders. The servo motors thus exert a force directed opposite to the contact pressure of the pressing cylinder. This configuration is consequently very inefficient, cost-intensive and structurally challenging and susceptible to faults as a result of the additional components.

It is therefore an object of the present invention to overcome the disadvantages of the state of the art. In particular, the present invention is directed to the object of providing a pressing cylinder for a material conveying device, wherein the pressing cylinder enables an increased cycle rate. In addition, a pressing cylinder should be provided which is flexibly adjustable in order to be able to process different strip materials in a material conveying device. It is generally an object of the invention to provide a pressing cylinder which is of structurally simple design, enables easier operation and automated adjustment to different strip materials, has little material wear, and is cost-effective.

### SUMMARY OF THE INVENTION

The above objects and further objects which emerge from the following description are achieved by the subject matter of the independent claims. Preferred embodiments are the subject matter of the dependent claims, and the person skilled in the art finds indications of other suitable embodiments of the present invention in the disclosure of the present application.

The goals and objects of the present invention are achieved inter alia with a pressing cylinder, as well as a corresponding material conveying device, and a method for adjusting a piston rod length of a pressing cylinder. The technical properties shown below for the pressing cylinder, the advantages of the pressing cylinder and the improvements over the state of the art apply equally to the material conveying device and the method.

### Pressing Cylinder—First Piston Rod Element Rotatable Relative to the Piston

A 1st embodiment of the invention relates to a pressing cylinder for a material conveying device, in particular for a roller feed, comprising: a piston rod which is configured to engage with a movable component of the material conveying device; a cylinder space which is configured to at least partially guide the piston rod; and a piston which is arranged movably in the cylinder space and which is connected to the piston rod; wherein the piston rod comprises a first piston rod element and a second piston rod element which are configured such that a rotational movement of the first piston rod element causes a translational movement of the second piston rod element relative to the piston; wherein the first piston rod element is configured rotatable relative to the piston.

The pressing cylinder according to the invention makes it possible to change, in particular set, a length of the piston rod. This is to be understood such that the length of the piston rod relative to the piston is changed. Therefore, the length of the piston rod can be set largely independently of a position of the piston. Advantageously, the path length which the piston performs in the cylinder space (stroke length) can thereby be made small. Therefore, the cylinder space (also to be understood as cylinder volume) can be made small. For example, an axial length of the cylinder space can be small. Therefore, the cycle rate (expressed in stroke/min) can be significantly increased compared to the state of the art. For example, cycle rates of at least 1000 strokes/min, preferably at least 1500 strokes/min, most preferably at least 2000 strokes/min can be achieved. This contributes significantly to an increase in the throughput of strip material.

Conventional pneumatic pressing cylinders require additional components in order to limit a stroke length, wherein the piston rod is not changed. The cylinder volume is still large in these conventional pressing cylinders, which is disadvantageous and inefficient.

The pressing cylinder according to the invention can also be flexibly set for different thicknesses of strip material, and furthermore provide an increased cycle rate. This ensures an overall more efficient processing of strip material in material conveying devices, in particular in roller feeds with follow-up cutting tools, for example punching tools.

The engagement of the piston rod with a movable component of the material conveying device can be understood such that a contact is present and in particular a pressure is applied by the piston rod to the movable component of the material conveying device during operation of the pressing cylinder in order to move the movable component. Here, the “operation” of the pressing cylinder is to be understood such that the piston of the cylinder moves. Therefore, an intermediate ventilation can be achieved as a result. This “operation” is not necessarily to be understood with the rotational movement of the first piston rod element and/or the translational movement of the second piston rod element relative to the piston. The latter serves to set a length of the piston rod. However, it is not ruled out that the latter also takes place during operation.

The cylinder space at least partially guides the piston rod. This can be understood such that the piston rod is at least partially in contact with the cylinder space. For example, the piston rod can be guided centrally through the cylinder space.

The piston is usually moved in the cylinder space during operation of the pressing cylinder, preferably it is moved up and down. The operation can take place, for example, pneumatically, therefore using compressed air. The piston is connected to the piston rod. This can be understood such that the piston rod can likewise move during a movement of the piston. The connection is advantageously not a fixed connection, which prevents a relative movement of the piston and the piston rod relative to one another in all directions (as also explained herein by a rotatable device).

The rotational movement of the first piston rod element is, for example, a rotational movement about the longitudinal axis of the first piston rod element, preferably about the longitudinal axis of the piston rod.

The translational movement of the second piston rod element can be understood in particular as a translational movement relative to the first piston rod element.

The first piston rod element is configured to be rotatable relative to the piston; this can be made possible, for example, by a bearing. Since the first piston rod element is configured to be rotatable relative to the piston, the rotational movement of the first piston rod element usually does not lead to a rotational movement of the piston. Therefore, it can advantageously be prevented that the piston causes frictional forces on a wall of the cylinder space (for example, if the piston were to co-rotate). Consequently, the arrangement contributes to low wear and facilitates the adjustment of the piston rod length. Therefore, the length of the piston rod can be changed in a material-saving manner, whereby the longevity can be increased.

A 2nd embodiment of the pressing cylinder relates to the preceding embodiment, wherein the piston and the first piston rod element are two separate components.

This makes it possible to adjust the piston rod length without impairing the piston, for example, without moving the piston. If wear of one of the two components should occur, it is sufficient to replace the worn component. The non-worn component can furthermore be used. This saves material and reduces costs.

In this embodiment, the second piston rod element could be moved translationally, in particular without significant expenditure of force. The inventors have succeeded in making this possible without significant expenditure of force, even if pressure is applied to the cylinder space (if pressure is exerted on the piston). For example, pressure could be applied to the pressing cylinder, with the result that the piston is arranged in an upper or lower position within the cylinder space. In such a position, the contact surface between the piston and a wall of the cylinder space can be increased (since, for example, an end face of the piston forms the contact surface in addition to a lateral surface). Consequently, if the piston were to co-rotate as an integral component with the first piston rod element during a rotational movement of the first piston rod element, the frictional forces would be significantly increased. Accordingly, a significantly increased expenditure of force would be necessary. As a result of the separation, this significant disadvantage can be overcome.

A 3rd embodiment of the pressing cylinder relates to one of the preceding embodiments, further comprising: a threaded rod arranged at least partly within the piston rod and substantially fixedly connected to the second piston rod element.

The threaded rod can be understood as a rod, e.g. an elongate component, which at least partly has a thread. The threaded rod can contribute to preventing an unintentional rotational movement of the first piston rod element as described herein. E.g., an unintentional rotational movement could occur during operation of the pressing cylinder. The fixed connection between the threaded rod and the second piston rod element can be understood such that the connection is not released during operation. However, both components can be released with the aid of further means if this is desired (for example in the case of a replacement of the components).

The arrangement of the threaded rod at least partly within the piston rod promotes space savings and can protect the thread from dirt.

A 4th embodiment of the pressing cylinder relates to one of the preceding embodiments, further comprising: a releasable locking device arranged substantially in the longitudinal direction of the piston rod at one end of the piston rod and configured to lock an adjustable length of the piston rod; wherein the locking device preferably comprises a screw connection optionally engaged with the threaded rod.

The locking device can comprise, for example, a nut, a lock nut or a knurled nut. A locking device is to be understood as a fixing, locking and/or blocking of movable components. The locking device is arranged in particular at one end of the first piston rod element of the piston rod. This end is typically the end facing away from the movable component of the material conveying device when the pressing cylinder is used in the material conveying device. Compared to arrangements with lateral locking devices, this arrangement achieves the advantage, for example, that the components do not protrude unnecessarily beyond the lateral dimensions. In addition, this arrangement enables a motorized and/or automated adjustment of the length of the piston rod.

By means of the locking device, an (undesired) change in a set length of the piston rod length can be reduced or substantially prevented. By means of the engagement with the threaded rod, a distance between the locking device and the second piston rod element can be kept substantially constant. In this way, a rotational movement of the first piston rod element during operation of the pressing cylinder is advantageously substantially prevented.

A washer can be arranged between the locking device and the piston rod. The threaded rod can protrude through the washer.

Preferably, a hand wheel can be provided which, during a rotational movement, exerts a correspondingly directed rotational movement on the first piston rod element. This can facilitate the adjustment of the piston rod length. The connection between the hand wheel and the first piston rod element can be made possible via a square connection. Usually, this connection is made such that, during operation of the pressing cylinder, the hand wheel moves translationally together with the piston rod and the piston (e.g. during intermediate ventilation). For this purpose, an air gap can be provided between the hand wheel and a wall of an upper cylinder component, with the result that friction losses are largely avoided. Preferably, the gap width of the air gap is selected to be so small that substantially no dirt passes through the air gap.

Pressing Cylinder—with Motor

A 5th embodiment of the invention relates to a pressing cylinder for a material conveying device, in particular for a roller feed, comprising: a piston rod which is configured to engage with a movable component of the material conveying device; a cylinder space which is configured to at least partially guide the piston rod; a piston which is arranged in the cylinder space and which is connected to the piston rod; and a motor; wherein the piston rod comprises a first piston rod element and a second piston rod element which are configured such that a rotational movement of the first piston rod element causes a translational movement of the second piston rod element relative to the piston; wherein the motor is configured to cause the rotational movement of the first piston rod element.

Advantageously, a motor is comprised in this embodiment, with which the adjustment of the piston rod length can be optimized. Conventional standard pneumatic cylinders do not enable any adjustment of the piston rod length and consequently also no motorized adjustment. The motor enables a meaningful integration of a control. An improved adjustment of the piston rod length can be achieved in the case of a strip material change. A complicated manual adjustment can then be dispensed with in a cost-reducing manner. A strip material change can be automated. The motor can be, for example, an electric motor. It is conceivable to use a servo motor, a stepper motor or a direct current (DC) motor. The examples of motors listed herein are in no way to be understood as limiting but serve only for understanding. A multiplicity of further technically meaningful motors can be used.

In particular, a combination of a motor for adjusting the piston rod length (as described herein) with a pneumatic operation of the pressing cylinder (as described herein) provides substantial advantages (as described herein) which do not emerge from conventional purely pneumatic pressing cylinders or purely electric cylinders.

A 6th embodiment of the pressing cylinder relates to the preceding embodiment, wherein the motor is configured not to cause a translational movement of the first piston rod element.

The motor does not have to be necessary for the operation of the pressing cylinder described herein, in particular for the intermediate ventilation. The operation of the pressing cylinder preferably takes place pneumatically, as described herein, as a result of which, for example, intermediate ventilation is achieved. During operation of the pressing cylinder, a translational movement of the first piston rod element therefore takes place. This advantageously does not have to be provided by the motor.

A 7th embodiment of the pressing cylinder relates to one of the preceding embodiments 5 or 6, wherein the motor is arranged substantially in the longitudinal direction of the piston rod at one end of the piston rod.

In one example, the motor could assume the function of a hand wheel for adjusting a piston rod length.

An 8th embodiment of the pressing cylinder relates to one of the preceding embodiments 5 to 7. wherein the piston rod, in particular the first piston rod element, is configured to be axially movable relative to the clutch; wherein preferably the piston rod, in particular the first piston rod element, is configured not to be rotatable relative to the clutch.

The motor can comprise a motor shaft. The motor can furthermore transmit a torque to the clutch, which torque is then transmitted to the piston rod, in particular only to the first piston rod element and not to the second piston rod element. During (pneumatic) operation of the pressing cylinder, the piston rod can move translationally, in particular axially, relative to the clutch and thus relative to the motor. For this purpose, a clearance, for example an air gap, can be provided. The air gap can be large enough to enable the relative translational movement. The air gap can be small enough to transmit a rotational movement (and the torque) of the clutch to the first piston rod element.

The piston rod, in particular the first piston rod element, is configured not to be rotatable relative to the clutch. This is to be understood such that the first piston rod element substantially does not rotate relative to the clutch. Consequently, an (undesired) change in a set length of the piston rod can be reduced or substantially prevented. In the embodiment with a motor, a locking device by means of a nut, a lock nut or a knurled nut is consequently not necessarily mandatory.

A 9th embodiment of the pressing cylinder relates to the preceding embodiment, wherein the clutch is configured not to perform a translational movement.

During (pneumatic) operation of the pressing cylinder, the clutch usually does not perform any movement (neither a rotational movement nor a translational movement). This reduces complexity and simplifies the movement mechanisms. For example, the clutch can be understood as a component substantially fixed in the axial direction. The same can consequently apply to the motor. Therefore, their positions during operation of the pressing cylinder are advantageously substantially fixedly determined, which brings advantages for the arrangement.

### Pressing Cylinder—General Embodiments

A 10th embodiment of the pressing cylinder relates to one of the preceding embodiments 5 to 9, wherein the pressing cylinder is a pressing cylinder according to one of the embodiments 1 to 4.

The person skilled in the art understands that the features, the technical properties, the advantages and the improvements of the pressing cylinder of the embodiments 1 to 4 over the state of the art likewise apply to the pressing cylinder of one of the embodiments 5 to 9 if this is technically meaningful.

An 11th embodiment of the pressing cylinder relates to one of the preceding embodiments, wherein the piston rod is configured to perform a stroke length of at most 5.0 mm, preferably at most 3.0 mm, further preferably at most 2.5 mm, even further preferably at most 2.0 mm, further preferably at most 1.5 mm, even further preferably at most 1.0 mm, further preferably at most 0.7 mm, most preferably at most 0.5 mm; and/or wherein the piston rod is configured to perform a stroke length of at least 0.005 mm, preferably at least 0.01 mm, further preferably at least 0.05 mm, most preferably at least 0.1 mm.

This stroke length (path length which the piston performs in the cylinder space during operation of the pressing cylinder) is substantially smaller compared to the state of the art. Consequently, a significant increase in the cycle rates (stroke/min or also number of strokes per minute) of the pressing cylinder for material conveying devices can be achieved compared to conventional configurations. Therefore, the conveying speed of strip material can be increased, as a result of which more efficient processing of strip material is made possible. The stroke length can be defined, for example, by an axial length of the cylinder space and/or by an axial length of the piston in the cylinder space. Usually, a small axial length of the cylinder space can be selected, with the result that the stroke length is reduced. This is material-saving.

It may be advantageous to provide a minimum stroke length and/or a larger stroke length. This can occur, for example, in the case of wider roller feeds and/or if movable components of the roller feed (for example a rocker) are flexible and/or if flexible strip materials (for example plastics) are to be conveyed. Flexible can be understood as bendable and/or elastic. Consequently, a larger stroke length can compensate system tolerances, which can be advantageous in some cases.

A 12th embodiment of the pressing cylinder relates to one of the preceding embodiments, wherein the rotational movement of the first piston rod element changes a length of the piston rod, wherein preferably the rotational movement in a first direction increases the length and the rotational movement in a second direction decreases the length.

The stroke length of the piston rod is small, but nevertheless strip materials with different thicknesses can be processed by increasing and decreasing the piston rod length. The pressing cylinder according to the invention can thus be flexibly used by the adjustability of the piston rod length. Consequently, different pressing cylinders do not have to be provided. A pressing cylinder which can meet a wide range of requirements, as described herein, is sufficient.

An increase in the piston rod length leads, for example, to a distance between two rollers of a material conveying device being reduced. A decrease in the piston rod length leads, for example, to a distance between two rollers of a material conveying device being increased.

Preferably, the ratio of the length of the piston rod which is set to a maximum length to the length of the piston rod which is set to a minimum length is approximately 110% to 150%, preferably 110% to 140%, further preferably 115% to 130%, most preferably 115% to 120% (or to 125%). Therefore, for example, an extension of the length of the piston rod from 10% to 50% can be accomplished.

Preferably, the minimum length of the piston rod can be 86 mm to 106 mm, for example 96 mm. Preferably, the maximum length of the piston rod can be 110 mm to 120 mm, for example 115 mm. This can correspond to a ratio of 115 mm/96 mm=119.8% (˜120%) described herein. With these values (ratios), the inventors enable the use of the pressing cylinder for a multiplicity of roller feeds of different passage regions.

A 13th embodiment of the pressing cylinder relates to one of the preceding embodiments, wherein the first piston rod element and the second piston rod element are engaged via a screw contact, in particular a thread.

The rotational movement of the first piston rod element causes a translational movement of the second piston rod element relative to the piston with the aid of a screw contact, for example a screw connection. Thus, the second piston rod element is driven via the thread of the screw contact. This represents a simplified and reliable movement mechanism.

A 14th embodiment of the pressing cylinder relates to one of the preceding embodiments, wherein the piston is configured to cause a corresponding translational movement of the piston rod during a translational movement of the piston.

When a translational movement of the piston is performed, the piston rod performs a corresponding, i.e. same and/or identical, translational movement. The first and the second piston rod element likewise move.

A 15th embodiment of the pressing cylinder relates to one of the preceding embodiments, further comprising: a sensor, preferably an eddy current sensor, which is configured to detect a current position of the piston, in particular in the cylinder space; wherein the sensor is preferably configured to detect a distance between the sensor and an underside of the piston.

The sensor is, for example, an analogue sensor. The sensor is preferably a contactless sensor. An eddy current sensor can reliably measure a distance by means of a magnetic field. Advantageously, these measurements are very precise.

A current position can comprise, in particular, the distance between the sensor and an underside of the piston. The detection can also be understood as a measurement. Advantageously, dimensions of components of the pressing cylinder are known, with the result that the extent to which the piston has moved can be determined with the aid of the measurement by the sensor. In this way, different thicknesses of a strip material can advantageously be determined. This can be helpful, for example, for the adjustment of the piston rod length in the case of a change of strip material.

In addition, the measurement can serve quality purposes, wherein an evaluation can take place via a control. Furthermore, with the aid of the detection of the current position, it can be determined whether intermediate ventilation has taken place. This is advantageous in particular in the case of the high cycle rates according to the invention. It can consequently be checked whether the pressing cylinder is still in the desired operation.

The measurement can also serve to detect material thickness fluctuations of a strip material during the feeding of the strip material through a material conveying device. The measurement results could be used, for example, to indicate a possibly (necessary) further adjustment process of the piston rod length (for example, a readjustment).

A 16th embodiment of the pressing cylinder relates to one of the preceding embodiments, wherein the piston rod is pneumatically driven, wherein the pressing cylinder is preferably configured such that translational movements of the piston and/or of the first piston rod element take place exclusively pneumatically.

A pneumatic drive represents a reliable technique, with which the operation, in particular the intermediate ventilation, of the pressing cylinder can take place efficiently. As described herein, the second piston rod element can also perform a translational movement on account of the rotational movement of the first piston rod element. This is possible and advantageous in addition to the pneumatic drive in order to set the piston rod length.

A 17th embodiment of the pressing cylinder relates to one of the preceding embodiments, further comprising: an upper air port; and preferably a lower air port; wherein the cylinder space is divided by the piston substantially into an upper cylinder space region, which communicates substantially exclusively with the upper air port, and preferably into a lower cylinder space region, which communicates substantially exclusively with the lower air port.

The air port can serve to provide a pressure in the cylinder space, which can lead to the piston moving in the cylinder space. Advantageously, two air ports are provided, which each communicate with a cylinder space region. The communication is to be understood such that an air exchange is made possible. Compressed air can thus be introduced in a targeted manner into the respective cylinder space region.

Two air ports offer the advantage of a double action compared to one air port. E.g., no basic/default position of the piston and/or of the piston rod is necessary. This can take place by an adjustment of the pressure.

The upper cylinder space region can, in the case of proper operation of the pressing cylinder, be understood such that, when pressure is applied, the piston and the piston rod increase a contact pressure. The lower cylinder space region can, in the case of proper operation of the pressing cylinder, be understood such that, when pressure is applied, the piston and the piston rod reduce a contact pressure. For example, the upper cylinder space region can be arranged vertically above the lower cylinder space region.

An 18th embodiment of the pressing cylinder relates to one of the preceding embodiments, further comprising: a spacer disc arranged in the cylinder space; wherein the spacer disc optionally has a thickness of at most 4.0 mm, preferably at most 3.0 mm, further preferably at most 2.5 mm, most preferably at most 2.0 mm; and/or wherein the spacer disc optionally has a thickness of at least 0.5 mm, preferably at least 1.0 mm, further preferably at least 1.5 mm, most preferably at least 2.0 mm.

The stroke length can be individually and flexibly adapted by means of the spacer disc. In one example, the stroke length of the piston can be reduced from 2.7 mm to 0.7 mm with the aid of a spacer disc of 2.0 mm thickness. In a further example, the stroke length of the piston can be reduced from 2.5 mm to 0.5 mm with the aid of a spacer disc of 2.0 mm thickness. Advantageously, increased cycle rates can therefore be achieved. Compared to the state of the art, in which pressing cylinders with stroke lengths of 10 mm are shown, substantial advantages consequently emerge.

The spacer disc is preferably arranged on an upper wall of the cylinder space, for example on an upper wall of the upper cylinder space region.

The thickness can be understood as an axial dimension of the spacer disc. The spacer disc can, in one example, have a shape which corresponds to a shape of the cylinder space. The spacer disc can typically be made cylindrical. The radius of the spacer disc is usually substantially greater than the thickness of the spacer disc, for example by a factor of at least 3, 5 or 8. The spacer disc, when it is arranged in the cylinder space, can also at least partially contact a lateral surface of the cylinder space. For the purpose of assembly, it can be advantageous if the spacer disc has a smaller radius than the cylinder space.

A 19th embodiment of the pressing cylinder relates to one of the preceding embodiments, further comprising: one, preferably two, plain bearings configured to receive the piston rod; and an upper cylinder component and a lower cylinder component, which are fixedly connected to each other and comprise the cylinder space, preferably enclose the cylinder space substantially air-tight; wherein the piston rod, the upper cylinder component and preferably the lower cylinder component are arranged coaxially, wherein preferably the piston rod protrudes at least partly over the lower cylinder component.

The arrangement of upper/lower cylinder component can be understood similarly to the arrangement of upper/lower cylinder space region. For example, the upper cylinder component can be arranged vertically above the lower cylinder component.

The air-tight closure can be understood such that substantially no pressure loss occurs during operation of the pressing cylinder. It is understood that a (planned) air exchange nevertheless takes place via the air port(s). An air exchange between the lower and the upper cylinder space region is substantially prevented.

A coaxial arrangement means that the components substantially have a common axis. For example, this is a longitudinal axis. This enables a simplified construction of the pressing cylinder.

A 20th embodiment of the pressing cylinder relates to one of the preceding embodiments, wherein the first piston rod element has a cavity, wherein the second piston rod element is arranged at least partly within the cavity, wherein preferably the first piston rod element and the second piston rod element are arranged coaxially.

The cavity enables a space-saving arrangement, as a result of which material and resources can be saved. In particular, no damage to the second piston rod element thus occurs. If a threaded rod is comprised, it can likewise be arranged in the cavity of the first piston rod element.

When the piston rod length is increased, the part of the second piston rod element arranged in the cavity is reduced. When the piston rod length is reduced, the part of the second piston rod element arranged in the cavity is increased.

In one example, if the piston rod length is set to a maximum length, the part of the second piston rod element arranged in the cavity can comprise at least 5%, preferably at least 10%, further preferably at least 20%, further preferably at least 25%, still further preferably at least 30%, most preferably at least 35% of a length of the second piston rod element; and/or at most 80%, preferably at most 70%, further preferably at most 60%, further preferably at most 50%, still further preferably at most 45%, most preferably at most 40% of a length of the second piston rod element.

In a further example, if the piston rod length is set to a minimum length, the part of the second piston rod element arranged in the cavity can comprise at least 20%, preferably at least 30%, further preferably at least 40%, further preferably at least 50%, still further preferably at least 60%, most preferably at least 65% of a length of the second piston rod element; and/or at most 95%, preferably at most 90%, further preferably at most 85%, further preferably at most 80%, still further preferably at most 75%, most preferably at most 70% of a length of the second piston rod element.

The inventors have succeeded in determining an optimum value of the part of the second piston rod element arranged within the cavity. This arises from the fact that the possible change in the piston rod length should be large enough to be able to handle a multiplicity of strip material thicknesses. At the same time, sufficient stability of the piston rod should be ensured. The values described herein of the part of the second piston rod element comprised by the cavity emerge from these opposing requirements.

It is conceivable for the cavity to extend over the entire length of the first piston rod element.

Advantageously, the screw contact comprises an internal thread of the first piston rod element and an external thread of the second piston rod element.

A 21st embodiment of the pressing cylinder relates to one of the preceding embodiments, wherein the second piston rod element engages with the movable component of the material conveying device, but not the first piston rod element; wherein the movable component of the material conveying device is preferably a rocker which is configured to cause a translational movement of a roller of the material conveying device during a movement.

Thus, only the engagement with the second piston rod element is accomplished. Consequently, the second piston rod element can preferably be mechanically designed for this engagement. The first piston rod element can consequently be mechanically designed differently. This increases the flexibility.

The first piston rod element can, in one example, also be understood as an upper piston rod element and the second piston rod element as a lower piston rod element. This serves for illustrating the arrangement (during normal operation of the pressing cylinder) and is in no way intended to apply restrictively. The two piston rod elements have an adjustable overlap region, preferably in terms of their respective axial dimension (as described herein).

During operation of the pressing cylinder, the pressure can be transmitted by the pressing cylinder to a rocker. The rocker is preferably a movable rocker which then passes on the pressure to the roller.

A 22nd embodiment of the pressing cylinder relates to one of the preceding embodiments, wherein the piston rod is configured such that the rotational movement of the first piston rod element causes substantially no translational movement of the first piston rod element relative to the cylinder space.

With this arrangement, it can be ensured that the first piston rod element does not displace axially when it performs a rotational movement. This is expedient since otherwise the rotational movement described herein would possibly be made more difficult. In addition, the rotational movement of the first piston rod element serves to move or displace only the second piston rod element translationally.

A 23rd embodiment of the pressing cylinder relates to one of the preceding embodiments, wherein the piston and the second piston rod element are two separate components, wherein preferably the first piston rod element and the second piston rod element are two separate components.

Separate components offer the advantage that in the case of wear of one of the components, a replacement of only the worn component is necessary. This reduces costs. In addition, the arrangement by means of separation enables the simplified adjustability of the piston rod length.

A 24th embodiment of the pressing cylinder relates to one of the preceding embodiments, wherein the translational movements run parallel to one another, wherein the translational movements preferably run substantially at right angles to a material which is to be conveyed by the material conveying device.

The translational movements can comprise the translational displacement/movement and/or axial displacement/movement described herein. The translational movements preferably run vertically, in the case of ordinary operation of the pressing cylinder.

A 25th embodiment of the pressing cylinder relates to one of the preceding embodiments, wherein the pressing cylinder is configured such that the piston performs a translational movement over the entire axial length of the cylinder space.

This offers the advantage that the pressing cylinder can be operated, for example, over the entire stroke length. The piston therefore preferably does not perform any movements during the stroke, wherein a movement reversal is carried out in a central axial region of the cylinder space. The axial length can be understood as parallel to the translational movement direction (as described herein). A separate component therefore does not necessarily have to be provided, as a result of which a translational movement of the piston is impaired or even reduced during operation. The pressing cylinder can advantageously always be operated in the same manner in this way, independently of a thickness of a strip material which is intended to be conveyed.

A 26th embodiment of the invention relates to a material conveying device, in particular a roller feed, comprising a pressing cylinder according to any one of the preceding embodiments.

The person skilled in the art understands that the technical properties shown herein for the pressing cylinder, the advantages of the pressing cylinder and the improvements over the state of the art apply equally to the material conveying device.

The material conveying device can consequently be operated with a significantly increased cycle rate. On account of the flexible adjustability of the pressing cylinder according to the invention, different strip materials can be processed in a material conveying device. This contributes to an efficient and cost-effective material conveying device.

According to a 27th embodiment, the material conveying device of the preceding embodiment further comprises a rocker and a roller; wherein the piston rod of the pressing cylinder is configured to increase a pressure on the rocker in order to cause a translational movement of the roller directed towards a material which is to be conveyed by the material conveying device; wherein the piston rod of the pressing cylinder is further configured to reduce a pressure on the rocker in order to cause a translational movement of the roller directed away from the material which is to be conveyed by the material conveying device.

The material conveying device according to the invention combines all the above-described advantages of the pressing cylinder with a roller and possibly with a rocker.

During operation of the pressing cylinder, an intermediate ventilation can take place (this is to be understood in this embodiment as an increase/reduction of the pressure). The intermediate ventilation serves, for example, to raise a roller after each feed cycle of the strip material in order to release the strip material for a follow-up cutting tool. The rocker can be configured such that, when the pressure on the rocker is reduced (for example, when the pressure on a surface of the piston is reversed, e.g., when the piston moves upward), the rocker is moved upward. The extension of the length of the piston rod does not necessarily lead to an increase in the pressure described herein. The extension of the length of the piston rod preferably does not lead to an increase in the pressure described herein. The pressure described herein preferably takes place pneumatically by means of the piston.

The movement direction towards the material can be understood, in one example, as directed vertically downward. The movement direction away from the material can be understood, in one example, as directed vertically upwards.

A 28th embodiment relates to the material conveying device according to any one of the preceding embodiments 26 or 27, wherein the rotational movement of the first piston rod element changes a distance, preferably an axial distance, of the piston rod and/or the roller to a material which is to be conveyed by the material conveying device, wherein preferably the rotational movement in a first direction decreases the distance and the rotational movement in a second direction increases the distance.

The piston rod length can be changed in order to change, for example, a basic/default position of the rocker and/or of the roller. As described herein, the rotational movement in the first direction causes a length of the piston rod to be increased. Consequently, a distance of the piston rod, the rocker and/or the roller to a strip material can be decreased. As described herein, the rotational movement in the second direction causes a length of the piston rod to be decreased. Consequently, a distance of the piston rod, the rocker and/or the roller to a strip material can be increased.

A 29th embodiment relates to the material conveying device according to any one of the preceding embodiments 26 to 28, wherein the pressure increase and/or the pressure reduction takes place pneumatically; wherein the rotational movement does not take place pneumatically.

A 30th embodiment of the invention relates to a method for adjusting a piston rod length of a pneumatic pressing cylinder in a material conveying device, in particular a pressing cylinder according to any one of the embodiments 1 to 25, comprising: optionally depressurizing the pressing cylinder; introducing material, in particular strip material, into the material conveying device; rotating a first piston rod element of a piston rod of the pressing cylinder in a first direction to cause a translational movement of a second piston rod element of the piston rod of the pressing cylinder; ending the rotating in the first direction when a contact or a predefined distance between a movable component of the material conveying device and the material is reached; optionally rotating, preferably when a contact has been reached, the first piston rod element in a second direction to cause an opposite translational movement of the second piston rod element.

The depressurizing can serve to enable the piston to be moved in one direction, for example, upwards, preferably entirely upwards. Therefore, the piston has reached an upper end of the cylinder space. This facilitates the adjustment of the length of the piston rod, for example, for thick strip material.

The rotating in the first direction can also be ended if a predefined distance is reached. This distance can be, for example, an axial, preferably a vertical distance between the rocker and/or roller (preferably roller) and the strip material (material).

In particular, if a motor is comprised, the method can take place in an automated manner. The rotating in the first direction advantageously takes place with the aid of the motor. The rotating in the first direction can take place in an automated manner until a contact between the roller and the strip material is reached. This contact can be determined, for example, by an increased current consumption of the motor. It is also possible to determine the contact by means of a sensor which is preferably arranged in the cylinder space. This sensor can be an eddy current sensor.

A rotating in the second direction can then be carried out. This rotating in the second direction should preferably take place only to the extent that the strip material is released. Advantageously, a distance between the roller and the strip material should be so small that, during a translational movement of the piston over the stroke length (during operation of the pressing cylinder), sufficient pressure can be built up between the roller and the strip material. This pressure should be sufficient to provide sufficient traction for a feed movement of the strip material. The pressure can vary in a strip material-specific manner and can be set by means of a pressure controller. A pressure in the range of 1.5 bar to 8 bar, preferably in the range of 2 bar to 6 bar, is conceivable.

Preferably, pressure is applied to the piston, with the result that the material conveying device is configured in an operationally ready manner in order to convey strip material.

A 31st embodiment relates to the method according to the preceding embodiment, further comprising: rotating the first piston rod element in the second direction, before the introduction of material.

This offers the advantage that the piston rod can be set to a reduced length, preferably to the smallest length. Consequently, this provides the possibility of conveying strip material with a large thickness.

### BRIEF DESCRIPTION OF THE FIGURES

Preferred embodiments are described below only by way of example. Reference is made to the following accompanying figures:

FIG. 1 shows a pressing cylinder in a material conveying device according to an embodiment of the present invention;

FIG. 2 shows a pressing cylinder according to a first aspect of the present invention in a perspective view;

FIG. 2a shows the pressing cylinder according to FIG. 2 in a lateral cross-sectional view;

FIG. 2b shows the pressing cylinder according to FIG. 2a, wherein the piston rod is extended;

FIG. 2c shows the pressing cylinder similarly according to FIG. 2a, wherein the piston is moved downwards in a translatory manner (the length of the piston rod is reduced to a minimum in relation to FIG. 2a);

FIG. 3 shows a pressing cylinder according to a second aspect of the present invention in a perspective view;

FIG. 3a shows the pressing cylinder according to FIG. 3 in a further perspective view;

FIG. 3b shows the pressing cylinder according to FIG. 3 in a lateral cross-sectional view;

FIG. 3c shows the pressing cylinder according to FIG. 3b, wherein the piston rod is extended;

FIG. 3d shows the pressing cylinder according to FIG. 3b, wherein the piston is moved downwards in a translatory manner;

FIG. 4 shows a pressing cylinder according to an embodiment of the present invention;

FIG. 5 shows a pressing cylinder according to a further embodiment of the present invention; and

FIG. 6 shows a schematic flow chart of a method for adjusting a piston rod length according to an embodiment of the present invention.

### DETAILED DESCRIPTION OF THE FIGURES

A rotational movement, rotation and turning can be understood synonymously herein.

A stroke length can also be understood as a path length, in particular as an entire path length which the piston performs in the cylinder space during operation of the pressing cylinder. This can also be understood as a piston stroke. For example, this can be an axial length between the piston and wall of the cylinder space. In some cases, the stroke length, as preferred herein, can correspond to an entire axial length of the cylinder space (minus a part occupied by the piston).

The pressing cylinder of the present invention can also be understood as an intermediate ventilation cylinder. The pressing cylinder is in no way intended to be understood as limiting with regard to the fact that the pressing cylinder necessarily brings about a pressing action. However, the pressing cylinder is intended to be suitable for a material conveying device and therefore differs, for example, from cylinders which are usually used in the operation of motor vehicles and/or piston machines.

Only a few possible embodiments of the invention are described in detail below. However, the present invention is not limited to these and a multiplicity of other embodiments can be used without departing from the scope of the invention. The embodiments presented can be modified and combined with one another in many ways, whenever they are compatible, and certain features can be omitted insofar as they appear to be superfluous. In particular, the disclosed embodiments can be modified by combining certain features of one embodiment with one or more features of another embodiment.

In the entire present figures and the description, the same reference signs refer to the same elements. It goes without saying that the reference signs (100-199) of the figures of the first aspect can likewise be used for the figures of the second aspect (with reference signs 200-299) and are, merely for the purpose of overview, not listed separately. The figures may not be to scale, and the relative size, proportions and illustration of elements in the figures may be exaggerated for clarity, illustration and expediency.

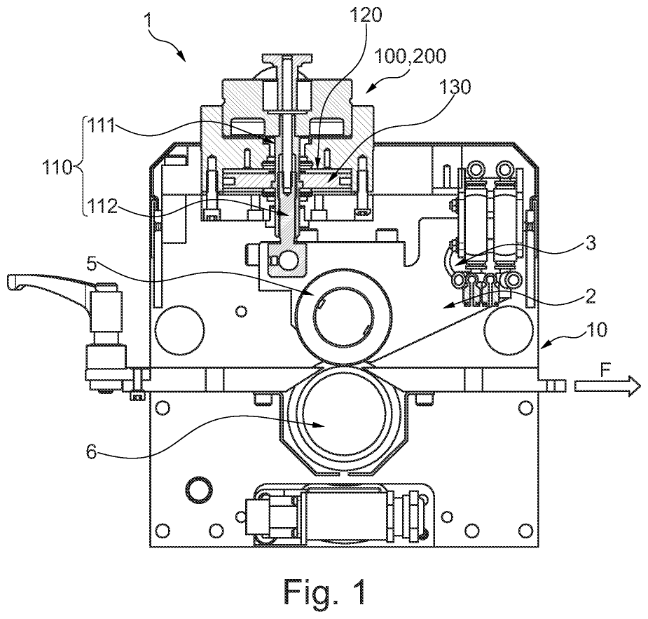

FIG. 1 shows a pressing cylinder 100, 200 (hereinafter the reference sign 200 is not listed separately but is likewise intended to be applicable) in a material conveying device (in particular in a roller feed) 1 according to an embodiment of the present invention.

The material conveying device 1 comprises a rocker 2 and a roller 5. In particular, the material conveying device 1 furthermore comprises a lower roller 6. The rollers 5, 6 of the material conveying device 1 can convey strip material 10 (not illustrated in FIG. 1 and merely indicated with a reference sign) in the conveying direction F.

The pressing cylinder 100 comprises a piston rod 110 which is configured to engage with a movable component 2 of the material conveying device 1. Furthermore, the pressing cylinder 100 comprises a cylinder space 120 which is configured to at least partially guide the piston rod 110. This means, for example, that the piston rod 110 extends through the cylinder space 120. Furthermore, a piston 130 is comprised which is arranged movably in the cylinder space 120 and which is connected to the piston rod 110 (for example at least partially by a form fit).

The piston rod 110 comprises a first piston rod element 111 and a second piston rod element 112 which are configured such that a rotational movement of the first piston rod element 111 causes a translational movement of the second piston rod element 112 relative to the piston 130. In this way, the length of the piston rod 110 can be changed.

The piston rod 110 of the pressing cylinder 100 is configured to increase a pressure on the rocker 2 in order to cause a translational movement of the roller 5 towards a strip material 10 which is to be conveyed by the material conveying device 1. The rocker 2 can rotate about the pivot point 3. The piston rod 110 of the pressing cylinder 100 is further configured to reduce a pressure on the rocker 2 in order to cause a translational movement of the roller 5 away from the strip material 10 which is to be conveyed by the material conveying device 1. The increase or reduction of the pressure takes place by means of a pneumatic operation of the drive cylinder 100 and can take place during intermediate ventilation, for example with at least 1500 strokes/min or at least 2000 strokes/min or at least 2500 strokes/min.

In this exemplary arrangement, the direction towards the material 10 can be understood as directed vertically downwards. The direction away from the material 10 can be understood as directed vertically upwards.

Strip materials with a thickness of 0.05 mm to 15 mm, preferably of 0.05 mm to 10 mm, further preferably of 0.05 mm to 8 mm, most preferably of 0.1 mm to 5 mm can be processed.

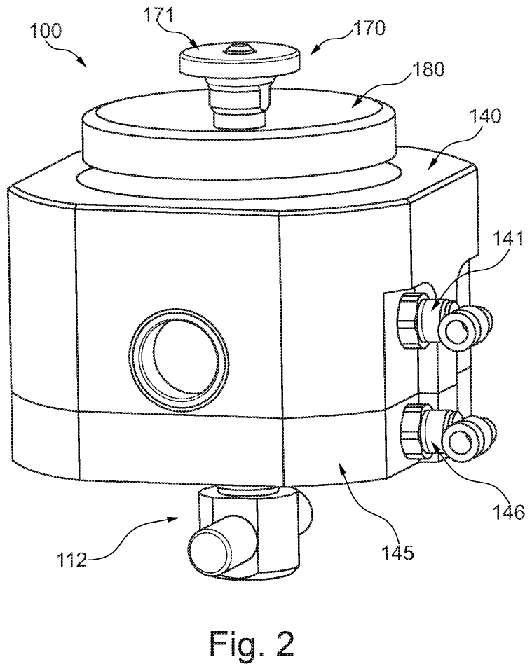

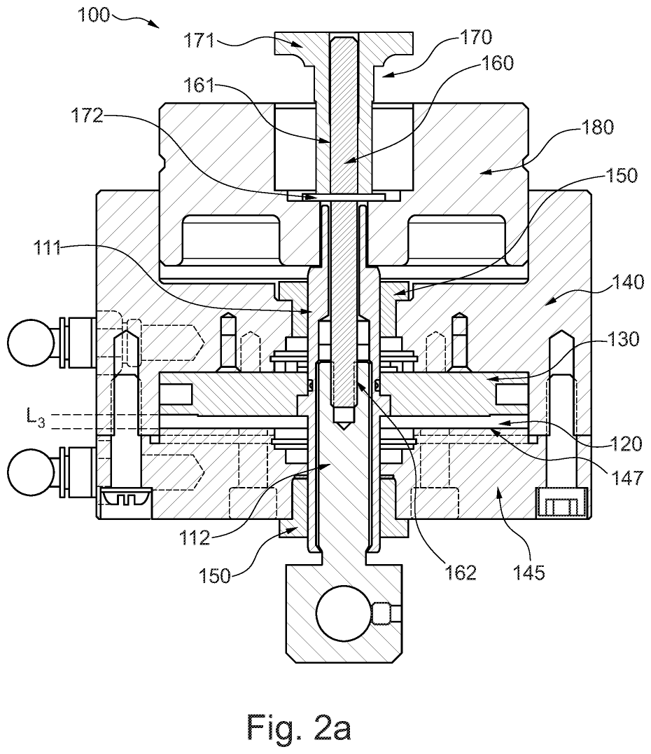

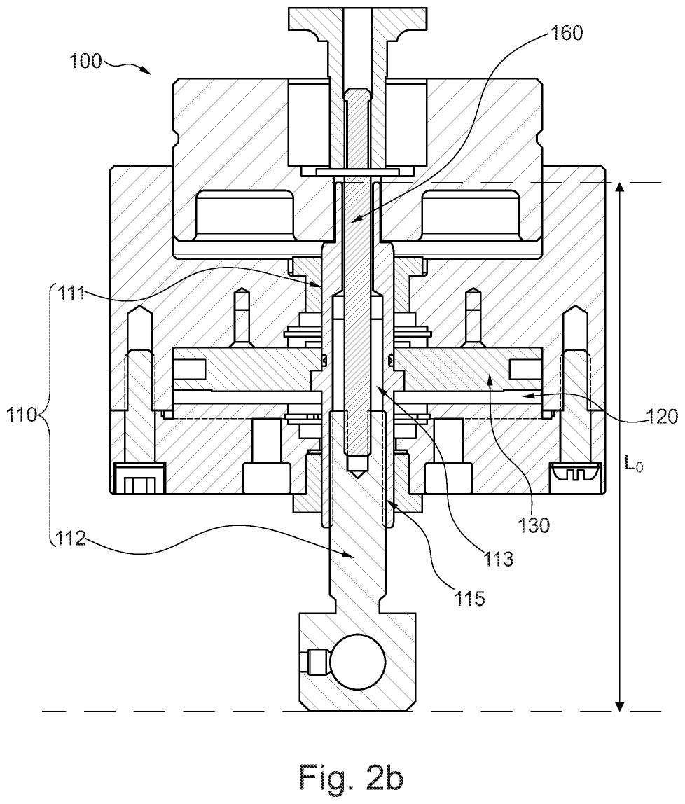

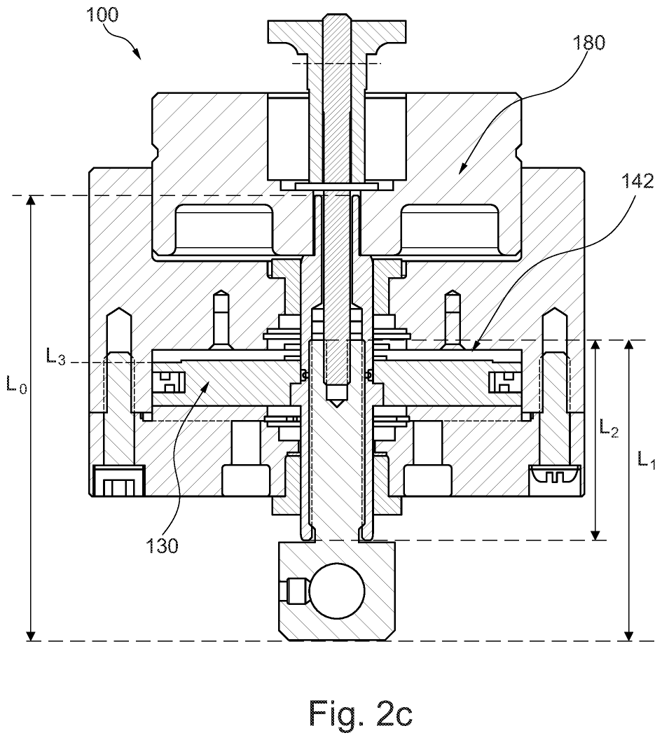

FIG. 2 shows a pressing cylinder 100 according to a first aspect of the present invention in a perspective view.

The pressing cylinder 100 comprises an upper cylinder component 140 and a lower cylinder component 145, which are fixedly connected to each other. For example via a screw connection. The two cylinder components 140, 145 enclose the cylinder space (not illustrated) in a substantially air-tight manner.

The pressing cylinder 100 furthermore comprises an upper air port 141 and a lower air port 146. Compressed air can be introduced into the cylinder space (or into an upper and into a lower cylinder space region) (pressure build-up) or let out (pressure reduction) through these air ports 141, 146.

The pressing cylinder 100 comprises a releasable locking device 170 arranged substantially in the longitudinal direction of the piston rod (only the second piston rod element 112 of the piston rod is indicated) at one end of the piston rod. The locking device 170 is configured to lock an adjustable length of the piston rod. The locking device 170 comprises a knurled nut 171 engaged with the threaded rod (not illustrated). The pressing cylinder 100 comprises a hand wheel 180 which, during a rotational movement, exerts a correspondingly directed rotational movement on the first piston rod element (not illustrated).

FIG. 2a shows the pressing cylinder 100 according to FIG. 2 in a lateral cross-sectional view.

The first piston rod element 111 and the second piston rod element 112 are illustrated. Both piston rod elements together form the piston rod 110 (not separately indicated).

The cylinder space 120 is divided by the piston 130 substantially into an upper cylinder space region 142, which communicates substantially exclusively with the upper air port 141, and into a lower cylinder space region 147, which communicates substantially exclusively with the lower air port 146. In this figure, the upper cylinder space region 142 is not illustrated and the space of the cylinder space 120 not filled by the piston 130 is defined substantially by the lower cylinder space region 147, since the piston 130 is illustrated in an upper end position.

The pressing cylinder 100 comprises two plain bearings 150 configured to receive the piston rod 110. In particular, the first piston rod element 111 is received by the two plain bearings 150.

The pressing cylinder 100 comprises a threaded rod 160 arranged at least partly within the piston rod 110, in particular within the first piston rod element 111. The threaded rod 160 is substantially fixedly connected to the second piston rod element 112.

A washer 172 is arranged between the locking device 170 and the piston rod 110 (indicated by 111 and 112). The threaded rod 160 protrudes through the washer 172. The threaded rod 160 is therefore arranged within the first piston rod element 111 and the knurled nut 171. The knurled nut 171 can be screwed via the upper thread 161 of the threaded rod 160 and then lock the rotational position of the hand wheel 180. Thus, for example, a set length of the piston rod 110 can advantageously not change during operation of the pressing cylinder 100.

The fixed connection between the threaded rod 160 and the second piston rod element 112 can take place via a screw connection, in particular via a lower thread 162 of the threaded rod 160. The connection can preferably take place with the aid of an adhesive, for example Loctite.

The piston rod 110 (indicated by 111 and 112), the upper cylinder component 140 and the lower cylinder component 145 are arranged coaxially. In addition, the piston rod 110, in particular the second piston rod element 112, protrudes at least partially beyond the lower cylinder component 145.

FIG. 2b shows the pressing cylinder 100 according to FIG. 2a, wherein the piston rod 110 is extended. Not all reference signs of the previous figure are reproduced merely for the purpose of overview. The corresponding reference signs of the preceding figures apply to components not explicitly indicated.

This figure shows an arrangement in which the length L0 of the piston rod 110 is extended. A comparison with the previous figure illustrates that the second piston rod element 112 is displaced translationally (axially downwards in the figure). A rotational movement of the first piston rod element 111 causes a change in the length of the piston rod 110. The rotational movement in a first direction increases the length L0 and the rotational movement in a second direction decreases the length L0. The first and the second direction are opposite. The rotational movement takes place by rotation about the longitudinal axis of the first piston rod element 111. The first piston rod element 111 and the second piston rod element 112 are engaged via a thread 115. The rotational movement is transmitted from the first piston rod element 111 to the second piston rod element 112 via this thread 115.

A hand wheel 180 is shown which, during a rotational movement, exerts a correspondingly directed rotational movement on the first piston rod element 111. This facilitates the adjustment of the length of the piston rod 110, since it has a larger radius than the first piston rod element 111 and thus requires a lower expenditure of force with constant torque. The connection between the hand wheel 180 and the first piston rod element 111 can be provided via a square connection.

The first piston rod element 111 has a cavity 113, wherein the second piston rod element 112 is arranged at least partly within the cavity 113. The first piston rod element 111 and the second piston rod element 112 are arranged coaxially.

If the length L0 of the piston rod 110 is set to a minimum length (similarly to FIG. 2c), the part L2 (the marking can be seen in FIG. 2c) of the second piston rod element 112 arranged in the cavity 113 is at least 20% and/or at most 95%, preferably at least 30% and/or at most 90%, for example 63% of the length L1 (the marking can be seen in FIG. 2c) of the second piston rod element 112.

If the length L0 of the piston rod 110 is set to a maximum length L0 (similarly to FIG. 2b), the part L2 (the marking can be seen in FIG. 2c) of the second piston rod element 112 arranged in the cavity 113 is at least 5% and/or at most 80%, preferably at least 10% and/or at most 70%, for example 38% of the length L1 (the marking can be seen in FIG. 2c) of the second piston rod element 112.

A comparison of the length L0 of the piston rod 110 which is set to a maximum length (FIG. 2b) to the length L0 of the piston rod 110 which is set to a minimum length (FIG. 2c) shows values in the range of 110% to 150%. In this example, a value of 120% arises, with the result that the piston rod 110 can advantageously be extended by 20% of its smallest length. Expressed in absolute values, the maximum length L0 can be 115 mm and the minimum length L0 can be 95 mm.

FIG. 2c shows the pressing cylinder 100 according to FIG. 2a, wherein the piston 130 is moved downwards. Moreover, the length L0 of the piston rod 110 is reduced to a minimum (in FIG. 2a, the length L0 of the piston rod 110 is not yet entirely reduced to a minimum).

During (pneumatic) operation of the pressing cylinder 100, the air ports serve to provide a pressure in the cylinder space 120, which leads to the piston 130 moving in the cylinder space 120. The position of the piston 130 at a lower end of the cylinder space 120 is illustrated. In this figure, the lower cylinder space region 147 is therefore not illustrated and the cylinder space 120 not filled by the piston 130 is defined substantially by the upper cylinder space region 142.

During (pneumatic) operation of the pressing cylinder 100, the hand wheel 180 is moved translationally together with the piston rod 110 and the piston 130 (e.g. during intermediate ventilation). For this purpose, an air gap can be provided between the hand wheel 180 and a wall of an upper cylinder component 140, with the result that friction losses are largely avoided. A comparison of FIGS. 2a and 2c indicates the arrangement of the hand wheel 180 in the two different positions of the piston 130 of the pressing cylinder 100.

The stroke length L3 is defined by an axial length of the cylinder space 120. In particular, the stroke length L3, as illustrated, can be described by means of the (axial) distance between the piston 130 and the upper end of the cylinder space 120. The stroke length L3 according to this figure is defined by the axial length of the upper cylinder space region 142.

Advantageously, a small axial length of the cylinder space 120 (or, as can be seen here, by the upper cylinder space region 142) is present, with the result that the stroke length L3 is made small. Consequently, an increased cycle rate can be achieved.

The piston 130 advantageously performs a translational movement over the entire axial length L3 of the cylinder space 120 (except for the axial length of the cylinder space 120 which is occupied by the piston 130). The entire axial length is illustrated by means of the stroke length L3.

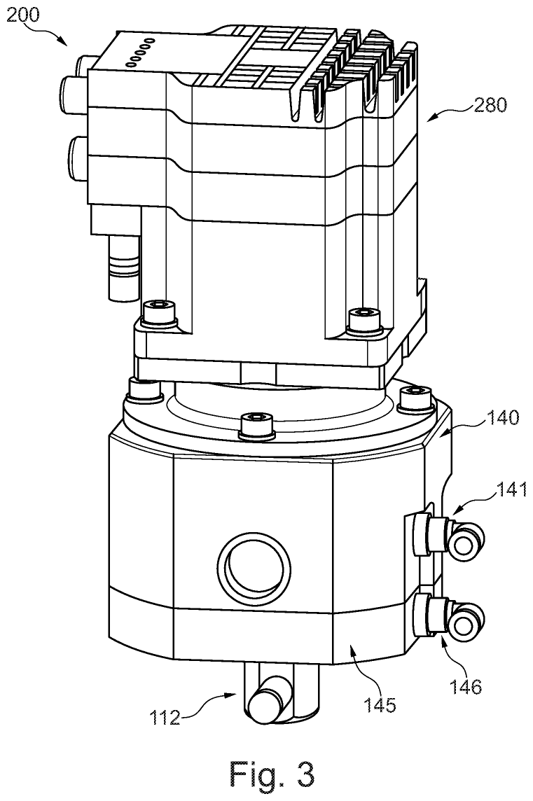

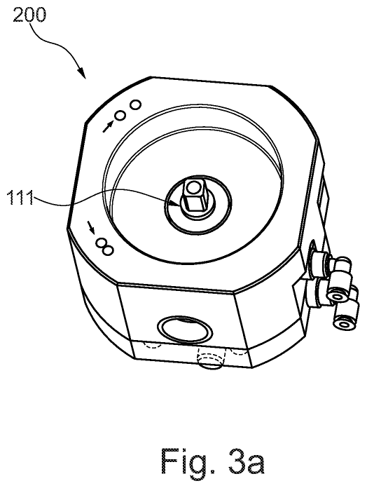

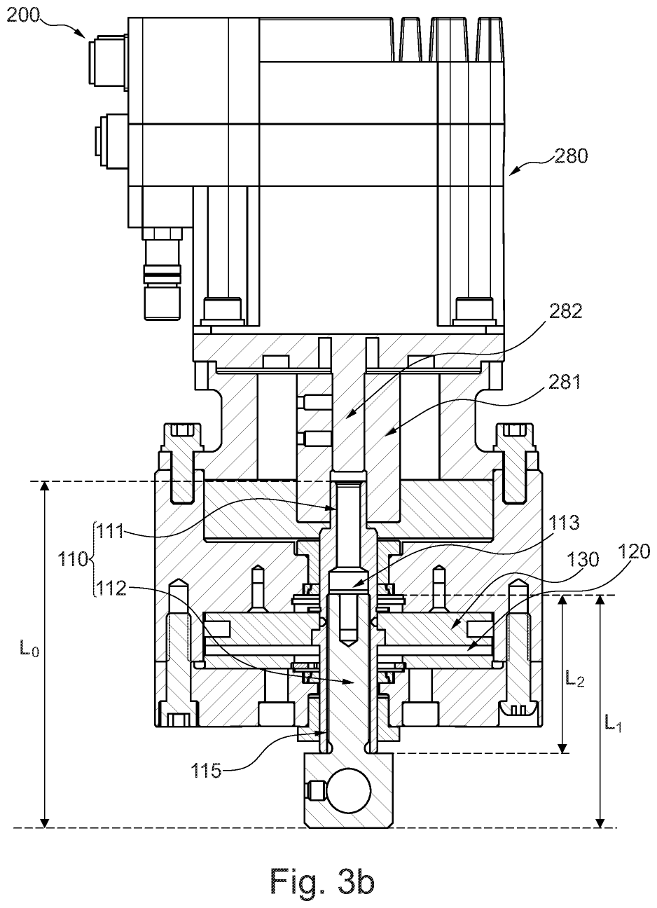

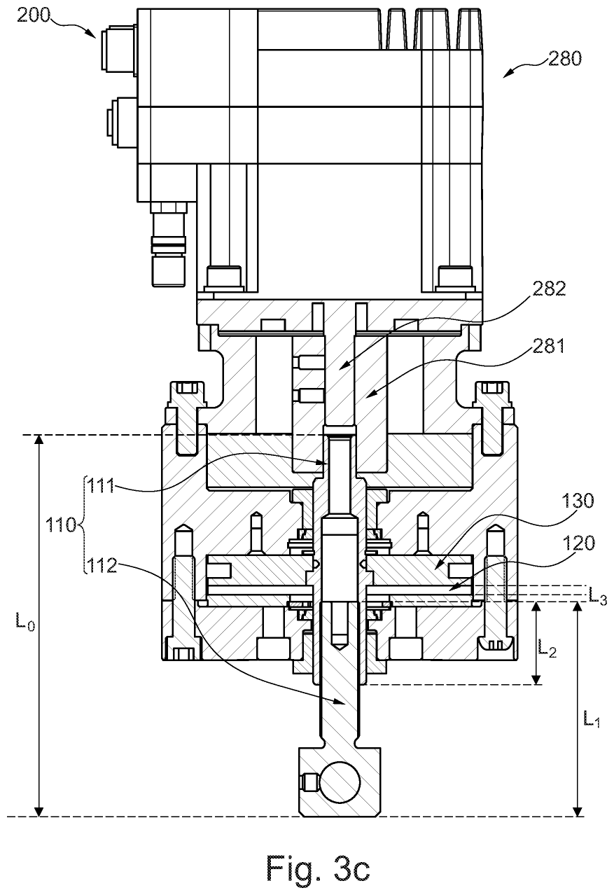

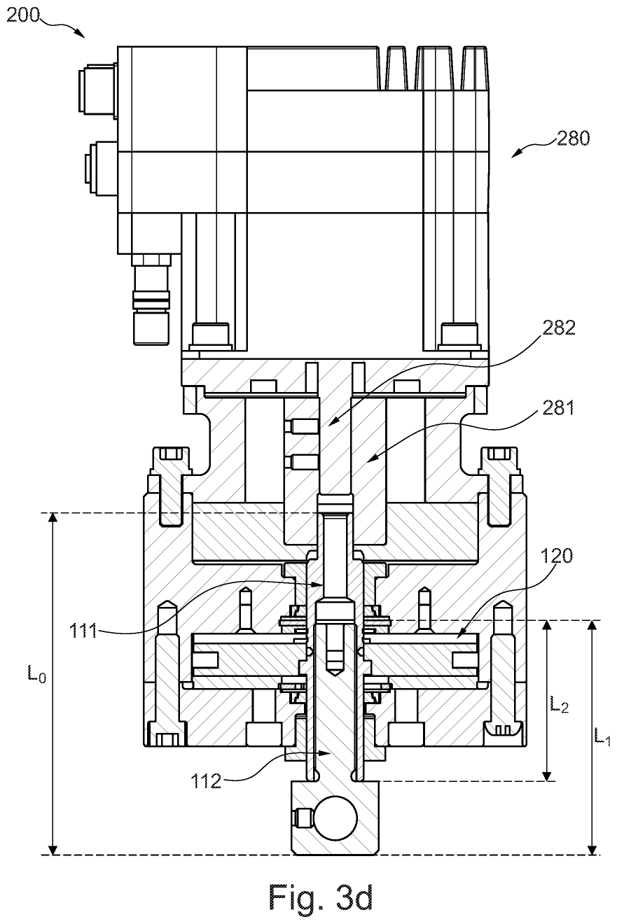

FIG. 3 shows a pressing cylinder 200, 100 (referred to below only as 200) according to a second aspect of the present invention in a perspective view. The person skilled in the art understands that the same reference signs correspondingly denote the same components of the first aspect. For example, 112 stands for the second piston rod element 112. The same components of the first aspect can consequently also be used for the second aspect. In the second aspect, a threaded rod, a handwheel and/or a separate locking device is advantageously not necessarily mandatory. In the second aspect, the first piston rod element 111 can advantageously be configured to be rotatable relative to the piston 130 (or the piston 130 can be configured to be rotatable relative to the first piston rod element 111).

The second piston rod element 112 comprises a fixing component, which can be a transverse pin, as a result of which a rotation of the second piston rod element 112 during rotation of the first piston rod element 111 can be substantially prevented. The fixing component protrudes laterally at least partially beyond a side surface of the piston rod. The fixing component can be in engagement with a movable component 2 of the material conveying device 1. The fixing component can be provided in all second piston rod elements 112 described herein. Alternatively or additionally, an installation position of the second piston rod element 112 in a movable component 2 of the material conveying device 1 can also substantially prevent a rotation of the second piston rod element 112 during rotation of the first piston rod element 111.

The pressing cylinder further comprises a motor 280 which is configured to cause the rotational movement of the first piston rod element 111.

FIG. 3a shows the pressing cylinder 200 according to FIG. 3 in a further perspective view.

In this figure, the pressing cylinder 200 is shown without the motor 280 for illustration purposes. It can be seen that the first piston rod element 111 has a square shape which enables a positively locking square connection to a clutch 281 of the motor 280.

FIG. 3b shows the pressing cylinder 200 according to FIG. 3 in a lateral cross-sectional view. This figure shows the components whose designations are apparent to the person skilled in the art inter alia from FIGS. 2-2c and are not listed again for reasons of overview.

The motor 280 further comprises a clutch 281 substantially fixedly connected to a motor shaft 282 of the motor 280, wherein the clutch 281 is engaged with the first piston rod element 111. The piston rod 110, in particular the first piston rod element 111, is configured to be axially movable relative to the clutch 281. The piston rod 110, in particular the first piston rod element 111, is configured not to be rotatable relative to the clutch 281. Thereby, the two components are substantially connected in a rotationally fixed manner (via the square connection described herein). The clutch 281 can thus prevent an (undesired) rotational movement of the first piston rod element 111 and/or cause a (desired) rotational movement of the first piston rod element 111. Consequently, an (undesired) change in a set length L0 of the piston rod 110 can be substantially prevented.

FIG. 3c shows the pressing cylinder 200 according to FIG. 3b, wherein the piston rod 110 is extended. The corresponding description passages of FIG. 2b apply for understanding the reference signs of this figure. In particular, the person skilled in the art analogously understands the change in the length L0 of the piston rod 110 between FIGS. 3b and 3c with the aid of the change in the length L0 of the piston rod 110 between FIGS. 2b and 2c (and between FIGS. 2b and 2a).

Advantageously, however, with reference to FIGS. 3b and 3c, the rotational movement of the first piston rod element 111 is caused by the motor 280.

If the length L0 of the piston rod 110 is set to a minimum length (similarly to FIG. 3b or also FIG. 3d), the part L2 of the second piston rod element 112 arranged in the cavity 113 is at least 20% and/or at most 95%, preferably at least 30% and/or at most 90%, for example 66% of the length L1 of the second piston rod element 112.

If the length L0 of the piston rod 110 is set to a maximum length, the part L2 of the second piston rod element 112 arranged in the cavity 113 is at least 5% and/or at most 80%, preferably at least 10% and/or at most 70%, for example 36% of the length L1 of the second piston rod element 112.

A comparison of the length L0 of the piston rod 110 which is set to a maximum length (FIG. 3c) to the length L0 of the piston rod 110 which is set to a minimum length (FIGS. 3b and 3d) shows values in the range of 110% to 150%. In this example, a value of 120% arises, with the result that the piston rod 110 can advantageously be extended by 20% of its smallest length.

FIG. 3d shows the pressing cylinder 200 according to FIG. 3b, wherein the piston is moved downwards. The length L0 of the piston rod 110 is reduced to a minimum as in FIG. 3b. The ratio of the length L2 to L1 is therefore greatest.

Similarly to the description in FIG. 2c, the piston 130 is illustrated in a lower position in FIG. 3d. E.g., this is achieved on account of the pneumatic operation of the pressing cylinder 200, as a result of which the piston 130 is moved downwards in a translatory manner (by pressure being applied into a lower air port, the piston 130 can be moved correspondingly upwards). The corresponding description passages of FIG. 2c likewise apply to FIG. 3d.

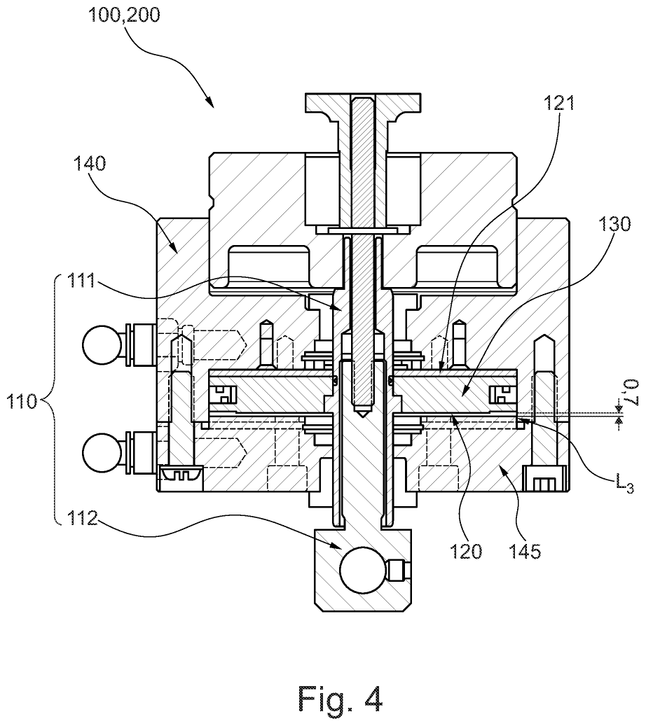

FIG. 4 shows the pressing cylinder 100, 200 according to an embodiment of the present invention. This embodiment is likewise used for both aspects.

The pressing cylinder 100, 200 comprises a spacer disc 121 which is arranged in the cylinder space 120. The spacer disc 121 has a thickness of at most 4.0 mm, and/or of at least 0.5 mm. In this example, it has a thickness of 2.0 mm. The stroke length L3 in this example is 0.7 mm (2.7 mm without spacer disc 121). Therefore, the stroke length L3 can advantageously be reduced. This enables higher cycle rates. For example, the stroke length L3 of 0.7 mm can also mean an intermediate ventilation opening of 0.7 mm which the pressing cylinder 100, 200 provides.

The spacer disc 121 is arranged on an upper wall of the upper cylinder space region 141 (not separately indicated), wherein this wall coincides with a lower wall of the upper cylinder component 140.

The (axial) end positions of the piston 130 in the cylinder space 120 are provided via a lower wall of the upper cylinder component 140 (or a spacer disc 121, as described herein) and an upper wall of the lower cylinder component 145.

For example, the pressing cylinder 100, 200 can enable at least 1500 strokes/min, or at least 2000 strokes/min. This advantageously provides high cycle rates. In one example, it could also be relevant how much time is available for performing the stroke. This can be influenced by an intermediate ventilation angle and/or a necessary (air) pressure:

The intermediate ventilation angle can influence the time that is available for performing an intermediate ventilation stroke (e.g., moving the piston upwards and moving the piston downwards). For example, an intermediate ventilation angle of 60° (assuming 500 strokes/min, which means 0.12 seconds/stroke) means that only 360°/60°=⅙ of the time is available for performing an intermediate ventilation (0.12 seconds/stroke/6=0.02 seconds/stroke). Consequently, in one example, at higher intermediate ventilation angles, higher cycle rates (higher strokes/min) can be performed (since more time is available). The example serves only for understanding and is not to be understood as limiting.

The influence by the pressure can be understood as follows: the less air pressure is required, the faster the cylinder space can be filled. At higher required air pressure, more air volume has to be introduced into the cylinder space, since the air can be compressed according to the ideal gas law under simplifying assumptions.

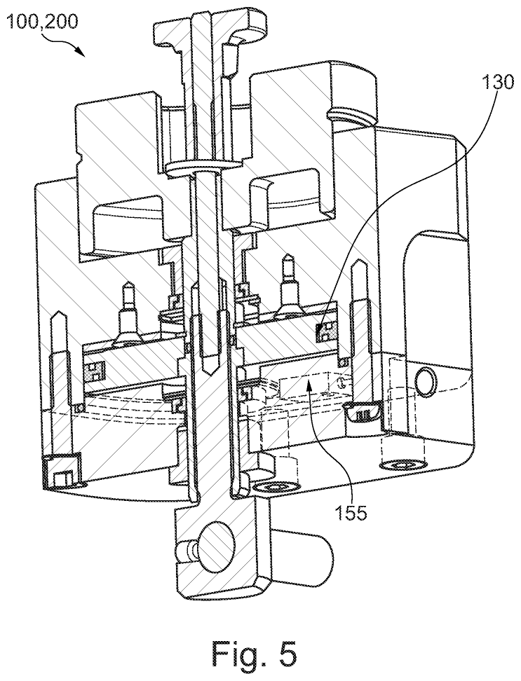

FIG. 5 shows the pressing cylinder 100, 200 according to a further embodiment of the present invention.

The pressing cylinder 100, 200 comprises a sensor 155, preferably an eddy current sensor 155, which is configured to detect a current position of the piston 130 in the cylinder space 120. The sensor 155 is configured to detect a distance between the sensor 155 and an underside of the piston 130.

The principle of a measurement by means of an eddy current sensor 155 can be understood as follows: if an electrically conductive body is moved in a magnetic field, eddy currents occur in this field, since a voltage is induced in the electrically conductive body. Therefore, dimensions, distances and/or positions, in particular of electrically conductive components, can be determined.

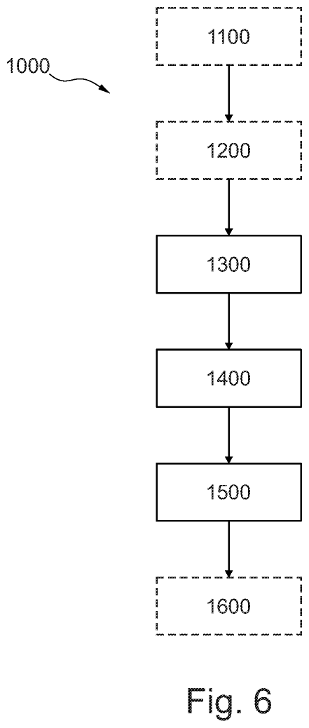

FIG. 6 shows a schematic flow chart of a method 1000 for adjusting a length L0 of a piston rod 110 of a pneumatic pressing cylinder 100, 200 in a material conveying device 1 according to an embodiment of the present invention. The method 1000 comprises: optionally depressurizing 1100 the pressing cylinder 100, 200; optionally rotating 1200 the first piston rod element 111 in the second direction; introducing 1300 material 10, in particular strip material, into the material conveying device 1; rotating 1400 a first piston rod element 111 of a piston rod 110 of the pressing cylinder 100, 200 in a first direction to cause a translational movement of a second piston rod element 112 of the piston rod 110 of the pressing cylinder 100, 200; ending the rotating 1500 when a contact or a predefined distance between a movable component 2, 5 of the material conveying device 1 and the material 10 is reached; optionally rotating 1600, preferably when a contact has been reached, the first piston rod element 111 in a second direction to cause an opposite translational movement of the second piston rod element 112.

In the above embodiments, it may be advantageous, in particular, that, in the case of thick strip material 10, the piston rod length 110 is usually reduced. In the case of thin strip material 10, the piston rod length 110 is usually increased.

The pressure (contact pressure) which is provided during operation of the pressing cylinder (for an intermediate ventilation) can sometimes depend on the strip material, in particular a surface of the strip material, an acceleration of the material conveying device to the strip material and a multiplicity of further parameters.

The scope of protection is determined by the patent claims and is not restricted by the exemplary embodiments and/or figures.

1. Pressing cylinder for a material conveying device, in particular for a roller feed, comprising:
a piston rod which is configured to engage with a movable component of the material conveying device;
a cylinder space which is configured to at least partially guide the piston rod;
a piston which is arranged in the cylinder space and which is connected to the piston rod; and
a motor;
wherein the piston rod comprises a first piston rod element and a second piston rod element which are configured such that a rotational movement of the first piston rod element causes a translational movement of the second piston rod element relative to the piston; wherein the motor is configured to cause the rotational movement of the first piston rod element.

2. The pressing cylinder according to claim 1, wherein the first piston rod element is configured to be rotatable relative to the piston.

3. The pressing cylinder according to claim 1, wherein the motor is configured not to cause a translational movement of the first piston rod element.

4. The pressing cylinder according to claim 1, further comprising:
a clutch substantially fixedly connected to a motor shaft of the motor, wherein the clutch is engaged with the first piston rod element;
wherein the piston rod, in particular the first piston rod element, is configured to be axially movable relative to the clutch;
wherein preferably the piston rod, in particular the first piston rod element, is configured not to be rotatable relative to the clutch.

5. The pressing cylinder according to claim 1, wherein the piston rod is configured to execute a stroke length selected from the group consisting of at most 5.0 mm, at most 3.0 mm, at most 2.5 mm, at most 2.0 mm, at most 1.5 mm, at most 1.0 mm, at most 0.7 mm, and at most 0.5 mm; and/or wherein the piston rod is configured to execute a stroke length selected from the group consisting of at least 0.005 mm, at least 0.01 mm, at least 0.05 mm, and at least 0.1 mm.

6. The pressing cylinder according to claim 1, wherein the rotational movement of the first piston rod element changes a length of the piston rod, and wherein the rotational movement in a first direction increases the length and the rotational movement in a second direction decreases the length.

7. The pressing cylinder according to claim 1, wherein the first piston rod element and the second piston rod element are engaged via a screw contact, in particular a thread.

8. The pressing cylinder according to claim 1, wherein the piston is configured to cause a corresponding translational movement of the piston rod during a translational movement of the piston.

9. The pressing cylinder according to claim 1, further comprising:
a sensor which is configured to detect a current position of the piston, in particular in the cylinder space;
wherein the sensor is preferably configured to detect a distance between the sensor and an underside of the piston.

10. The pressing cylinder according to claim 1, wherein the piston rod is pneumatically driven,
wherein the pressing cylinder is preferably configured such that translational movements of the piston and/or of the first piston rod element take place exclusively pneumatically.

11. The pressing cylinder according to claim 1, further comprising:
a spacer disc which is arranged in the cylinder space;
wherein the spacer disc optionally has a thickness selected from the group consisting of at most 4.0 mm, at most 3.0 mm, at most 2.5 mm, and at most 2.0 mm;
and/or wherein the spacer disc optionally has a thickness selected from the group consisting of at least 0.5 mm, at least 1.0 mm, at least 1.5 mm, and at least 2.0 mm.

12. The pressing cylinder according to claim 1, wherein the first piston rod element has a cavity, wherein the second piston rod element is arranged at least partly within the cavity,
wherein preferably the first piston rod element and the second piston rod element are arranged coaxially.

13. The pressing cylinder according to claim 1, wherein the pressing cylinder is configured such that the piston performs a translational movement over the entire axial length of the cylinder space.

14. Material conveying device, in particular a roller feed, comprising a pressing cylinder according to claim 1.

15. Method for adjusting a piston rod length of a pneumatic pressing cylinder in a material conveying device, in particular a pressing cylinder according to claim 1, comprising:
optionally depressurizing the pressing cylinder;
introducing material, in particular strip material, into the material conveying device;
rotating a first piston rod element of a piston rod of the pressing cylinder in a first direction to cause a translational movement of a second piston rod element of the piston rod of the pressing cylinder;
ending the rotating when a contact or a predefined distance between a movable component of the material conveying device and the material is reached;
optionally rotating, preferably when a contact has been reached, the first piston rod element in a second direction to cause an opposite translational movement of the second piston rod element.
